(19) United States
(12) Patent Application Publication
(10) Pub. No.: US 2020/0253222 A1
(43) Pub. Date: Aug. 13, 2020

(54) Method To Making Cheesecake Sandwiches

(71) Applicant: Lisa Ann Cotoggio, Bayside, NY (US)

(72) Inventor: Lisa Ann Cotoggio, Bayside, NY (US)

(21) Appl. No.: 16/269,843

(22) Filed: Feb. 7, 2019

(51) Int. Cl. A21D 13/19; A21D 13/50

(52) U.S. Cl. CPC A21D 13/19; A21B 3/138; A21D 13/50

(57) ABSTRACT

The disclosure involves the method and process in which to manufacture an edible cheesecake sandwich that can be consumed by the masses. A baked good that allows people of all ages to enjoy a novelty dessert combination of cookies, and cheesecake in a predetermined individual serving size that creates a new delivery system integrated during the baking process allowing a defined heat exchange to alter the molecular structure of the two compounds to create a handheld cheesecake sandwich, which can be eaten without the use of plates and cutlery in any location at any time in the 24-hour cycle of a day.

### FIELD OF INVENTION

The present invention relates generally to baking, and the baking industry. More specifically, to a method of making cheesecake sandwiches that allows for a single process baking procedure that changes the molecular structure during the heat exchange creating one solid form that enables for one-handed, grab-and-go cheesecake sandwich consumption without the use of plates and cutlery.

### BACKGROUND OF THE INVENTION

While the baking industry continues to surpass the 50 billion mark throughout the United States in the current climate, one must admit that two of their standouts, cheesecake and cookies have continually been in the top five picks for consumers when it comes to choosing their dessert, regardless of: (a) demographic; (b) annual gross income or (c) religious beliefs. Sweets are sweets, and we all love them, and consume them on a regular basis because in short, they appeal to the masses.

Research also shows that today's consumer is: (a) smarter; (b) busier than ever; and (c) continuously on the hunt for convenience, especially when it comes to eating on the go. But at the same time, they are seeking to find products that are more wholesome in nature, and contain real ingredients as opposed to those that are genetically modified, and contain preservatives.

There are many types of cheesecake on the market today, but let's face it, all require the consumer to sit down, be it at a restaurant or in their home with a plate, fork or spoon, and in some circumstances, even with a knife to enjoy their beloved velvety dessert.

There are also instances in which a retail bakery or home baker will, with the use of baked or store bought cookies attempt to put their two favorite desserts together by slicing off a piece of their baked or store bought cheesecake, and on some occasions a dollop of either cream cheese or a no-bake cheesecake product, and slapping it between two of their favorite cookies and calling it a “so-called” sandwich. However, when one picks this up, and attempts to eat it several things happen: (a) the person seeking to eat it falters with the three pieces as they try to maneuver it into their mouth; (b) their initial first bite into a hard and semi-soft product causes the hard cookies to break into multiple pieces as the not-so-solid center shoots out all over the place, once again bringing them back to a messy dessert that must be eaten on a plate with a fork, spoon, and/or knife.

The consumer, and the millennial especially are constantly in search of products filled with natural ingredients that can be eaten on the run, hence the “grab-and-go” term during their hectic work and play schedules. The average consumer today no longer has the time to sit down and eat the way they did in the span of the last century. Today, everything is on the go, fast, fast, fast, with only minutes to consume something before they move on to the next task at hand they are required by work, family, and play obligations to complete.

It is therefore, an object of the present invention to provide a baking method in which to facilitate cheesecake sandwiches, a novel dessert that combines two of the world's top five most favorite desserts into one easy to eat confectionary treat.

A further object of this invention is to provide a simple process and baking method with the use of flexible molds that are readily available in the marketplace today for the commercial baking industry, home baker, and novice baker to create and manufacture cheesecake sandwiches for consumption in a capacity to serve a small dinner party, mid-sized event or a production run for the masses.

A further object of this invention is to provide a hand to grab-and-go cheesecake sandwich that can be eaten by a consumer without the use of plates and cutlery, anytime, anywhere, in a fast pace that satisfies their sweet craving without mess, and allows them to focus their attention instantaneously on the other parts of their day in a manner of which they have now come to accept as their normality.

A further object of this invention is to provide a novel process for the combination of soft twice baked cookies to bind with a light, fluffy cheesecake batter that adheres during the heat exchange changing the molecular structure to create one solid form that can be stored in a freezer for a period of six months with minimal thawing times or remanded to a refrigeration unit for 7-10 days without the use of preservatives, while holding its taste, quality, and form for pure enjoyment at time of consumption, which has already been proven in the marketplace with minimal local start-up sales, and repeat customers.

Further objects and advantages of this invention will be apparent from the following detailed description of a presently advantageous embodiment.

### SUMMARY OF THE INVENTION

Embodiments of the present invention generally relate to a method of making cheesecake sandwiches that can be produced in a variety of flavors with the addition of added fillings such as fruits, chocolate chips, caramel, nuts, etc. to the center of the cheesecake batter, if so requested in a pre-determined size; a novel form of two favored dessert items; cookies and cheesecake served through an entirely new delivery system that allows the consumer to access this sweet treat as a grab-and-go item with one-hand consumption foregoing the use of plates and cutlery.

Full details of the present invention are set forth in the following description of the invention.

### BRIEF DESCRIPTION OF THE DRAWINGS

In the drawings:

FIG. 1 is a readily available sheet of 15 flexible silicone molds in a predetermined size;

FIG. 2 is an individual flexible silicone mold that has been separated from its original sheet;

FIG. 3 is (1) twice-baked soft cookie being placed in the bottom of the individual flexible silicone mold;

FIG. 4 is cheesecake batter being poured on top of (1) twice-baked soft cookie inside the individual flexible silicone mold;

FIG. 5 is (1) twice-baked soft cookie being placed on top of the cheesecake batter completing the sandwich effect in the individual flexible silicone mold prior to baking;

FIG. 6 is an 18″×26″ commercial baking pan containing 20 individual flexible molds that have been separated from their original sheets after the 20 individual cheesecake sandwiches have been baked and removed from the oven;

FIG. 7 is a cheesecake sandwich as it is removed from the individual flexible silicone mold after the baking and chilling process is complete;

FIG. 8 is the finished product; a cheesecake sandwich ready to eat.

### DETAILED DESCRIPTION OF THE INVENTION

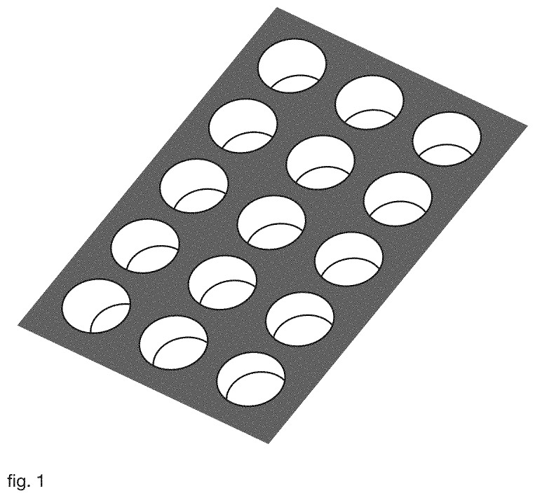

With reference now to the illustrations, FIG. 1 the sheet of 15 flexible molds also known as silicone cavities in a predetermined size provides an ease of use to the commercial baking industry, home baker, and novice baker in a way a metal pan does not, and cannot sustain. The mere flexibility in being able to peel, fold or pop out the delicate cheesecake sandwich prevents damage and loss, not just to the cheesecake sandwich itself, but also to the cost spent to make and manufacture them. The silicone pans and baking molds as they are referred are readily available nationwide not just to the commercial baking industry, but also to the home baker and novice baker at a reasonable cost that allows the method of this novel invention to take hold easily by anyone seeking to produce it.

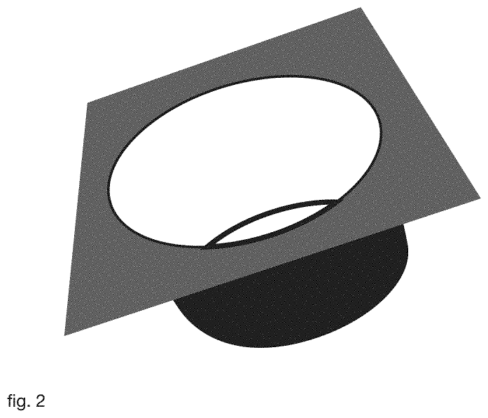

In FIG. 2 we see an individual flexible mold also known as a silicone cavity in a predetermined size that has been separated from the original sheet it was manufactured on. It is this process of separation that allows for easy handling during the preparation, baking, and removal of the cheesecake sandwich.

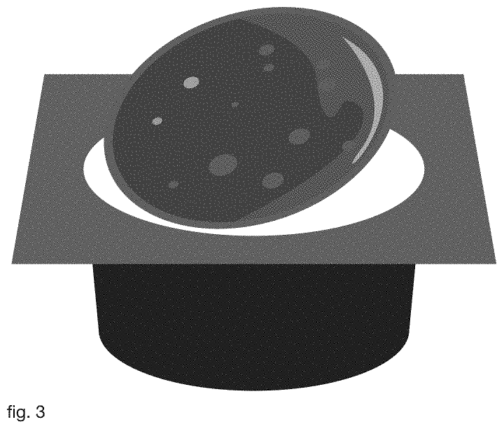

FIG. 3 illustrates a soft twice-baked cookie as it is placed into the individual flexible mold. The cookie at this stage, is pre-baked once before insertion into the silicone cavity, and can be made in a variety of flavors, such as plain, chocolate or other desired choices by mixing and combining certain ingredients in distinct measures that allow for its soft twice-baked texture. These main ingredients include buttercream, shortening, egg yolks, whipped cream, baking soda, salt, powdered sugar, pastry flour and bread flour. Once the dough is prepared, a circle shape (other shapes can be substituted, such as hearts, stars, etc.) in a predetermined size is stamped out. The cookies are then baked for roughly 8 minutes at 440 degrees. After at least 10-15 minutes of cooling, the cookies are placed into the bottom of the silicone cavities.

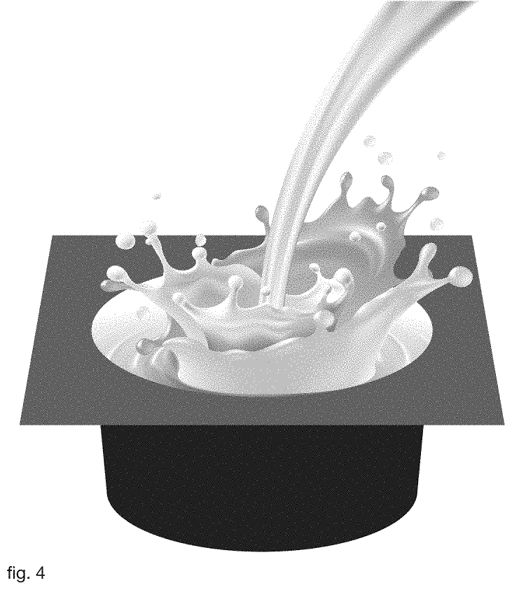

A cheesecake batter having a light, fluffy consistency is prepared and poured on top of the soft twice-baked cookie in a four-ounce measure, FIG. 4. The cheesecake batter for this method of invention is unlike the customary cheesecake products being produced and sold on the market today. This cheesecake batter is created by mixing predetermined measures of sugar, cream cheese, egg yolks, salt, heavy cream, flour and vanilla, leaving the egg whites to be whipped into a meringue separately, thereby folding them into the semiliquid mixture at the end, which creates an almost soufflé like quality, and superior taste during the baking process. Other flavors can be added in such as milk chocolate, chocolate chips, amaretto paste, and/or fillings such as fruits, caramel, nuts etc. to create a variety of cheesecake sandwich choices.

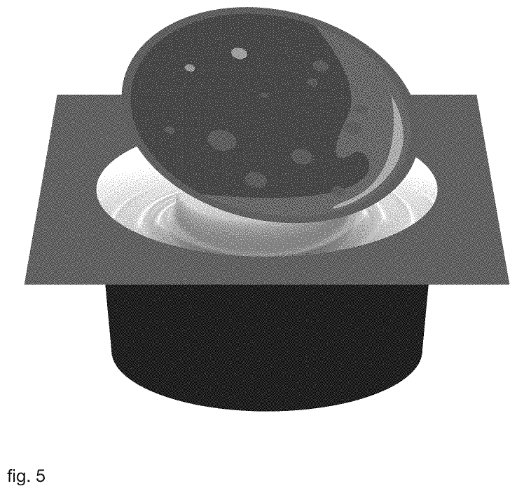

Once the batter has been added to the flexible mold, a second soft twice-baked cookie is then placed on top of the uncooked batter, FIG. 5. The silicone cavities are then placed on a metal baking sheet pan for support. Water is then distributed to the bottom of the baking sheet pan creating a water bath as they are placed in the oven. A temperature of 325 degrees for the first 30 minutes of baking is required, with a 30 minute cool down baking period to follow at a lower temperature of 275 degrees, (35 minutes is required for milk chocolate cheesecake sandwiches).

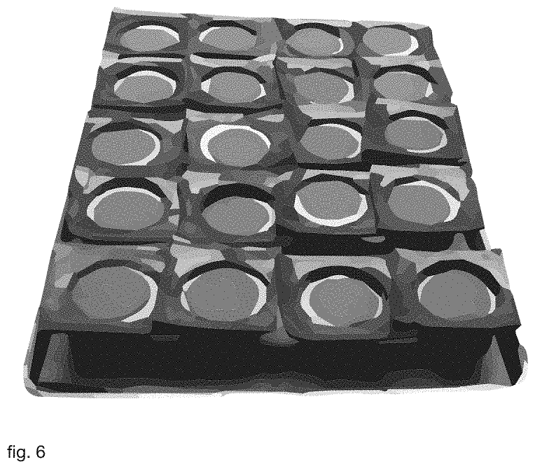

FIG. 6 illustrates an 18″×26″ baking sheet pan containing 20 individual silicone cavities that were separated from their original sheets after completion of the baking process. For easy handling, each flexible mold is transferred to a cool baking sheet pan, and then stored in the freezer overnight.

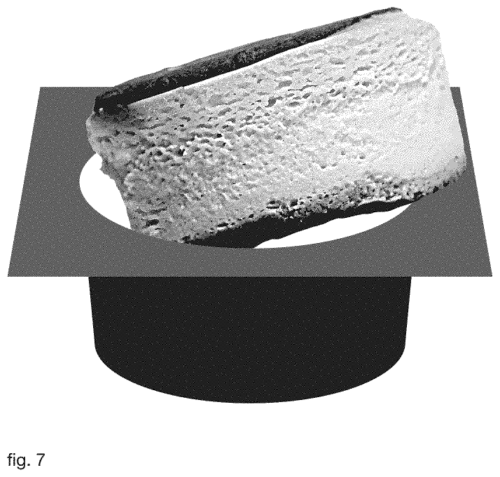

FIG. 7 reveals our cheesecake sandwich in one piece as it is being removed from the flexible mold. The mold itself is best peeled during the frozen state of the cheesecake sandwich to prevent damage. Whereby, the cheesecake batter and soft twice-baked cookies have combined during the heat exchange changing the molecular structure to a solid form, which can be frozen for six months, thawed and consumed; refrigerated up to 7-10 days and consumed or eaten immediately without the use of unnatural ingredients or preservatives.

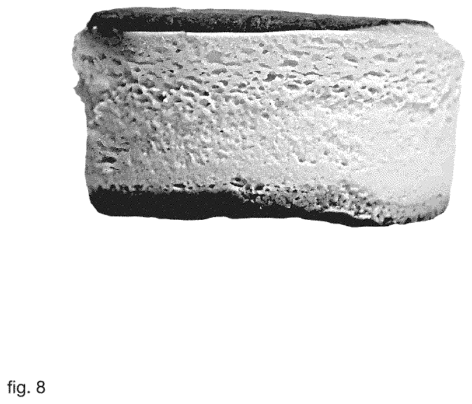

FIG. 8 demonstrates the end result in this method of invention, which allows for the making of a cheesecake sandwich through a baking process that adheres all of the ingredients into one creating a new, unique and novel delivery system that allows the consumer one-handed access to a delicious grab-and-go type cheesecake sandwich without the use of plates and cutlery.

I claim:

1. A method to making cheesecake sandwiches which comprises:
a. a cookie dough that allows for twice-baked process;
b. a cheesecake batter that allows for a light, fluffy consistency due to the addition of meringue;
c. a baking process in a silicone muffin mold that combines the two entities (cookies and cheesecake) into one solid form due to the introduction of meringue which creates a better adhesion
d. a freezer process that allow for the easy removal of the cheesecake sandwich from the silicone muffin mold without damage.

2. A method in accordance with claim 1 that produces an individually portioned 4 ounce cheesecake sandwich dessert that enables a one-handed, grab-and-go style delivery system, which allows for the consumption of the 4 ounce cheesecake sandwich dessert without the use of plates and cutlery, anytime, anywhere.

3. A method in accordance with claim 1 whereas a predetermined mix of ingredients with the introduction of meringue creates an airy batter that allows the cheesecake batter to adhere better to the cookies during the baking process, and prevents separation of the cheesecake and cookies when one bite's into it with the addition of the twice-baked Linzer cookie.
